(19) United States
(12) Patent Application Publication
(10) Pub. No.: US 2017/0268483 A1
(43) Pub. Date: Sep. 21, 2017

(54) WIND POWER GENERATION SYSTEM

(71) Applicant: INDUSTRY-ACADEMIC COOPERATION FOUNDATION YONSEI UNIVERSITY, Seoul (KR)

(72) Inventors: Jongbaeg KIM, Goyang (KR); Hyunseok YANG, Seoul (KR); Jongsoo LEE, Seoul (KR); Joon Sang LEE, Seoul (KR)

(21) Appl. No.: 15/351,392

(22) Filed: Nov. 14, 2016

(30) Foreign Application Priority Data
Mar. 21, 2016 (KR) 10-2016-0033398

(51) Int. Cl. F03D 5/06; F03D 9/25; F03D 9/00; H02N 2/18; H02K 7/18

(52) U.S. Cl. CPC F03D 5/06; H02N 2/185; H02K 7/1892; F03D 9/002; F03D 9/25

(57) ABSTRACT

Disclosed herein is a wind power generation system using a dynamic lift generation disk structure unlike a horizontal-axis wind turbine(HAWT) or vertical-axis wind turbine(VAWT) which uses blades. The wind power generation system includes a column and an oscillating unit. The oscillating unit includes a donut shape wing(disk) surrounding the column, which can convert kinetic energy into electric energy when the unit is moving up or down by dynamic lift.

### CROSS REFERENCE TO RELATED APPLICATION

The present application claims the benefit of Korean Patent Application No. 10-2016-0033398 filed in the Korean Intellectual Property Office on Mar. 21, 2016, the entire contents of which are incorporated herein by reference.

### BACKGROUND OF THE INVENTION

1. Technical Field

The present invention relates to a wind power generation system and, more particularly, to a wind power generation system using a dynamic lift generation disk structure unlike a horizontal-axis wind turbine(HAWT) or vertical-axis wind turbine(VAWT) which uses blades.

2. Description of the Related Art

Wind power generation for producing electric energy using the wind is a technological field that continues to be researched and invested in that it is clean energy not generating environmental pollution. In a wind power generation system, it is important to obtain an equipment cost versus high power generation efficiency and to select a proper location on which the wind power generation system is to be established. maintenance and management for the wind power generation apparatus is also important. In order to improve and supplement such a point, wind power generation systems having various types and structures have been developed so far.

FIG. 1 is a perspective view of a wind power generation system using a horizontal-axis wind turbine(HAWT) using a conventional blade. FIG. 2 is a perspective view of a conventional vertical-axis wind power generation system. FIG. 3 is a perspective view of a wind power generation system using a turbine of a bladeless type.

Referring to FIG. 1, the wind power generation system 1a of blade type includes a tower 5 formed at a high height, large-sized blades 3, a hub 2 on which the blades 3 are mounted, a generator connected to the hub and configured to generate electric power, and a driving unit 4 configured to control the pitch angle of the blade.

Although the blade type generation system is typically used in wind power generation systems, the blade type generation system has problems with rotor noise and bird collision. Furthermore, the blade type generation system has a disadvantage in that mechanically complicated elements, such as a bevel gear for yawing, must be disposed within the hub in order to handle a change in the direction of the wind. Furthermore, the blade type generation system may have a problem in that power generation efficiency is low due to a wake between adjacent wind power generators because the wind power generators are collectively disposed in a narrow section of the plant site. Moreover, the blade type generation system may have a problem in that it has many restrictions in terms of stability and the selection of a place when the wind power generator is established

Referring to FIG. 2, the wind power generation system 1b of a vertical-axis wind turbine includes a rotor 3b (or wing) that rotates 360 degrees around a rotor shaft 5b instead of the blades, a support and so on.

In the vertical-axis wind type generation system, when the rotor shaft is rotated by the force of the wind applied to the rotor, an AC power generator operates to produce electricity. The vertical-axis wind type generation system may be said to have been improved from the blade-type in that electric power is generated by only a movement of the blade and an element, such as the bevel gear for yawing, is not required. However, the vertical-axis wind type generation system has a noise problem attributable to rotation and problems, such as a danger of a bird collision. Furthermore, safety means, such as a lateral support element 6, must be provided because the rotor shaft 5b is rotated along with the rotation of the rotor 3b. Furthermore, the vertical-axis wind type wind generation system has many problems in terms of residential receptivity like the aforementioned blade type turbine system.

FIG. 3 shows a new wind power generation system 1c of a bladeless type from which the blades have been removed in the conventional blade type turbine.

The wind power generation system of FIG. 3 has advantages in that it can reduce the cost of materials, a danger of a bird collision and a noise problem, because the blades are not required in this generation system. However, such a bladeless type generation system has disadvantages in that it has a complicated mechanism for converting mechanical energy into electric energy because a vibration direction is not constant, it may have low efficiency because an instable eddy is generated, and it is suitable for a small-sized wind power generation system, but is not suitable for a large-sized wind power generation system.

### SUMMARY OF THE INVENTION

Accordingly, the present invention has been made keeping in mind the above problems occurring in the prior art, and an object of the present invention is to disclose a wind power generation system of a dynamic lift generation disk type of a new concept, which is capable of removing problems, such as a rotor noise, shadow and a bird collision generated in the existing wind power generators, which is free from an building place limit, and which can improve residential acceptivity.

In accordance with an embodiment of the present invention, a wind power generation system includes a column and an oscillating unit. The oscillating unit includes a wing unit of a disk form having a hollow portion formed therein in such a way as to surround the column, whereby the wing unit converts kinetic energy into electric energy when the wing unit moves up or down by dynamic lift.

In accordance with an embodiment of the present invention, a perpendicular section of the wing unit may have an airfoil shape having a virtual chord line which connects a leading edge forming the outermost circumference and a trailing edge forming the innermost circumference around the central axis of the column. The perpendicular section of the wing unit may have an asymmetrical section in which an upper half surface has a wider width than a lower half surface.

In accordance with an embodiment of the present invention, a plurality of the oscillating units may be formed.

In accordance with an embodiment of the present invention, the oscillating unit may further include a cylindrical sleeve for supporting the wing unit.

In accordance with an embodiment of the present invention, a gap for a flow of a fluid may be formed between the wing unit and the sleeve, and at least one connection member may be formed to connect the wing unit and the sleeve.

In accordance with an embodiment of the present invention, the wind power generation system may further include an elastic member for elastically supporting the oscillating unit.

In accordance with an embodiment of the present invention, the elastic member may include an elastic member supporting the bottom of the oscillating unit and an elastic member supporting the top of the oscillating unit. The elastic member supporting the bottom of the oscillating unit may have a higher spring constant than the elastic member supporting the top of the oscillating unit.

In accordance with an embodiment of the present invention, at least one dimple may be formed in a surface of the wing unit.

In accordance with an embodiment of the present invention, the conversion of the kinetic energy into the electric energy may be performed using an electromagnetic induction method, a piezoelectric method or a slider-crank method.

In accordance with an embodiment of the present invention, a main magnetic body for generating electric energy in synchronization with the up or down motion of the oscillating unit may be provided within the column. A coil may be disposed around the main magnetic body.

In accordance with an embodiment of the present invention, the wind power generation system may further include a guide unit configured to support the main magnetic body and to guide the perpendicular motion of the oscillating unit. The main magnetic body may be disposed at each of the top and bottom of the guide unit.

In accordance with an embodiment of the present invention, a main magnetic body disposed to generate electric energy in synchronization with the up or down motion of the oscillating unit and an auxiliary magnetic body disposed to face the main magnetic body may be provided within the column. The auxiliary magnetic body may have polarity different from polarity of the main magnetic body so that a repulsive force is formed between the auxiliary magnetic body and the main magnetic body.

In accordance with an embodiment of the present invention, the piezoelectric unit may be disposed under the auxiliary magnetic body.

In accordance with an embodiment of the present invention, the wing unit may include a variable wing unit configured to vary so that an upper half surface of the perpendicular section of the wing unit has a wider width than a lower half surface of the perpendicular section during the up motion and the upper half surface of the perpendicular section of the wing unit has a narrower width than the lower half surface during the down motion.

In accordance with an embodiment of the present invention, the wing unit may include a variable wing unit configured to change an included angle formed by a chord line and a virtual plane orthogonal to the central axis of a tower.

In accordance with an embodiment of the present invention, the wind power generation system may further include a control unit and a driving actuator which enable a fine operation of the wing unit to be artificially manipulated.

In accordance with an embodiment of the present invention, the wing unit may include a first ring member configured to form the circumference of the leading edge of the wing unit, a second ring member configured to form the circumference of the trailing edge of the wing unit, and a canopy connected between the first ring member and the second ring member.

In accordance with an embodiment of the present invention, wherein the canopy may be made of a flexible material and may have a varying section shape.

### BRIEF DESCRIPTION OF THE DRAWINGS

FIG. 1 is a perspective view of a wind power generation system using a horizontal-axis wind turbine(HAWT) using a conventional blade.

FIG. 2 is a perspective view of a conventional vertical-axis wind type power generation system.

FIG. 3 is a perspective view of a wind power generation system using a turbine of a bladeless type.

FIG. 4(a) is a perspective view showing the upper part of a wind power generator according to an embodiment of the present invention.

FIG. 4(b) is a perspective view showing the lower part of the wind power generator according to an embodiment of the present invention.

FIG. 5 is a diagram showing the principle that the dynamic lift of a wing unit is generated according to an embodiment of the present invention.

FIG. 6 is a diagram showing the perpendicular section of the wing unit according to an embodiment of the present invention.

FIG. 7(a) shows a conceptual diagram of the wind power generator in which the wing unit and a column have been formed according to an embodiment of the present invention.

FIG. 7(b) is a simulation diagram showing the current around the wing unit when the wind is applied to the wind power generator.

FIG. 8(a) is an enlarged cross-sectional view of the FIG. 7 and is a simulation diagram showing the wing unit and the current around the wing unit that first comes into contact with the wind. FIG. 8(b) shows a flow around the section of the wing unit at a portion spaced 180 degrees apart from the wing unit of FIG. 8(a).

FIGS. 9(a) and 9(b) are respectively a top view and bottom view of FIG. 8 and is a simulation diagram showing a pressure distribution on a surface of the wing unit.

FIG. 10 is a perspective view of a wind power generation system according to another embodiment of the present invention.

FIG. 11 is a diagram showing the principle that the wind power generator of FIG. 10 operates.

FIG. 12 is a diagram showing the internal structure of the wind power generation system using an electromagnetic induction method.

FIG. 13 is a diagram showing a slit structure of the wind power generation system according to an embodiment of the present invention.

FIG. 14 is a diagram showing the operating principle of FIG. 12.

FIG. 15 is a diagram showing the wind power generation system using an electromagnetic induction method according to another embodiment.

FIG. 16 is a diagram showing the internal structure of the wind power generation system using a piezoelectric method.

FIG. 17 is a diagram showing the operating principle of FIG. 16.

FIG. 18 is a diagram showing a wind power generation system using a wing unit to which a canopy has been applied.

FIG. 19 is a diagram showing the principle that the wing unit of FIG. 18 moves up.

FIG. 20 is a diagram showing the principle that the wing unit of FIG. 18 moves down.

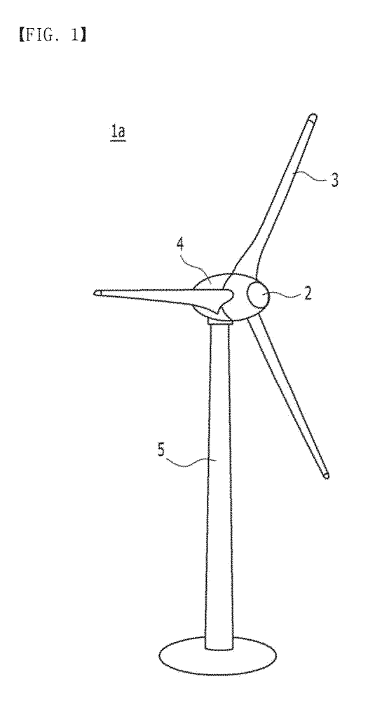

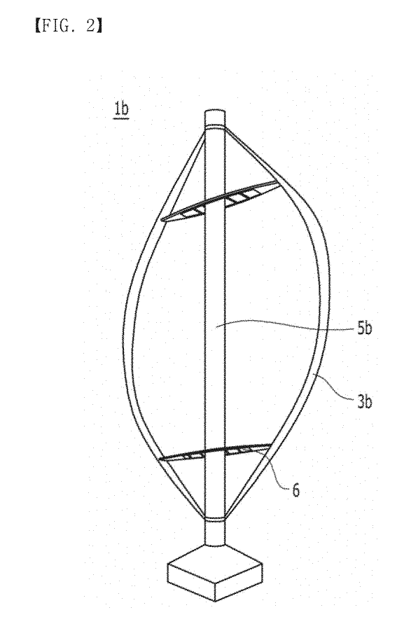

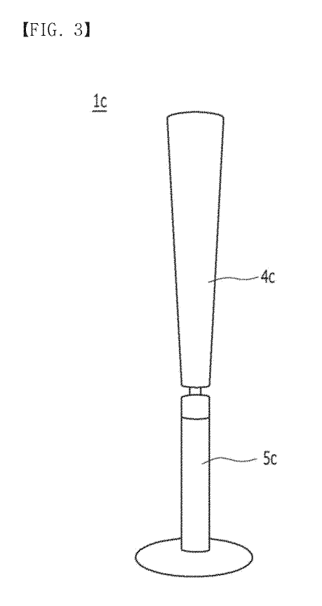

### DETAILED DESCRIPTION

Embodiments to be described hereunder are provided in order for those skilled in the art to easily understand the technical spirit of the present invention, and the present invention is not restricted by the embodiments. Furthermore, contents expressed in the accompanying drawings have been diagrammed to easily describe the embodiments of the present invention, and may be different from those that are actually implemented.

In this case, the term “connect” includes a direct connection or an indirect connection between one member and the other member, and may mean all of physical connection or electrical connections, such as adhesion, attachment, coupling, joining and combination.

More specifically, when it is said that one element is “connected” or “coupled” to the other element, it should be understood that one element may be directly connected or coupled” to the other element, but a third element may exist between the two elements. Furthermore, in the entire specification, when it is described that one member is placed “on or over” the other member, it means that one member may adjoin the other member and a third member may be interposed between the two members.

Furthermore, expressions, such as “the first” and “the second”, or reference numerals, such as “1”, “100” and “200” expressed in the drawings, are used to only distinguish a plurality of elements from one another and do not limit the sequence or other characteristics of the elements.

It should be appreciated that the use of the terms “include(s)”, “comprise(s)”, “including” and “comprising” is intended to denote the presence of the characteristics, numbers, steps, operations, elements, or components described herein, or combinations thereof, but is not intended to exclude the probability of presence or addition of one or more other characteristics, numbers, steps, operations, elements, components, or combinations thereof.

In the following description, a Z axis (i.e., a perpendicular direction) may mean a direction parallel to the length direction of a column. An X axis (i.e., a lateral direction) may mean a direction that is orthogonal to the Z axis and is parallel to the lateral section of the column. A Y axis (i.e., a lateral direction) may mean a direction that is orthogonal to the Z axis and the X axis and is parallel to the lateral section of the column.

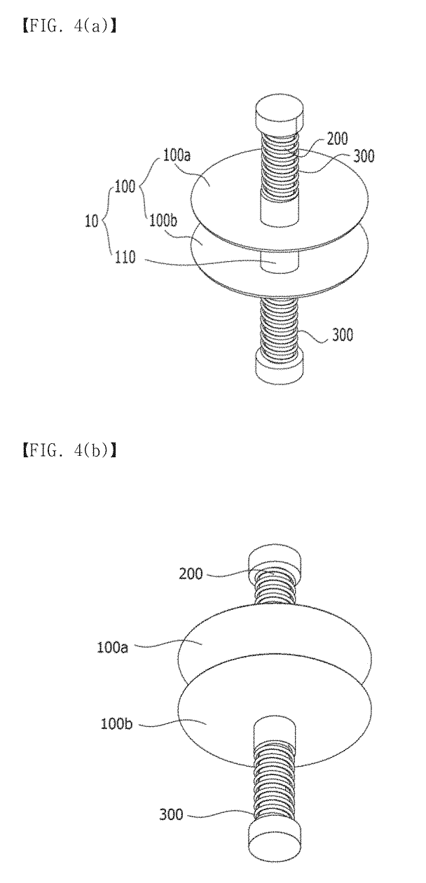

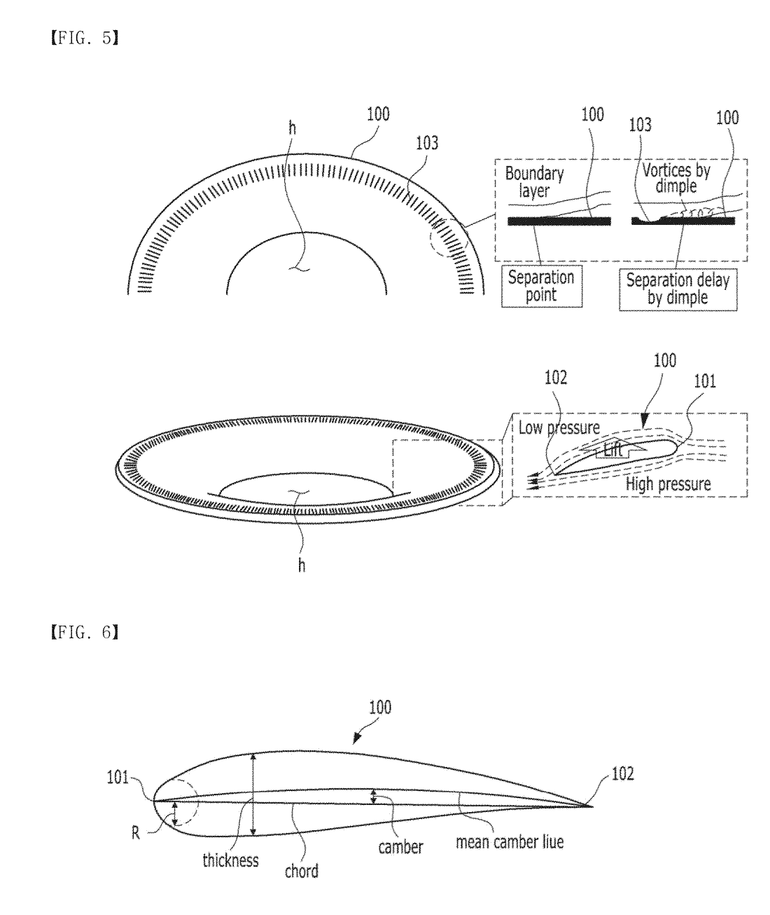

FIG. 4 is a perspective view showing a wind power generator according to an embodiment of the present invention. More specifically, FIG. 4(a) is a perspective view showing the upper part of the wind power generator according to an embodiment of the present invention. FIG. 4(b) is a perspective view showing the lower part of the wind power generator according to an embodiment of the present invention. FIG. 5 is a diagram showing the principle that the dynamic lift of a wing unit is generated according to an embodiment of the present invention. FIG. 6 is a diagram showing the perpendicular section of the wing unit according to an embodiment of the present invention.

The wind power generator according to an embodiment of the present invention may include a column 200 and an oscillating unit 10. The oscillating unit 10 may include a wing unit 100 of a disk form, which has a hollow portion “h” formed therein so that the wing unit surrounds the column 200.

The oscillating unit 10 according to an embodiment of the present invention is a portion that vibrates up and down along the column 200, and obtains mechanical kinetic energy by the wind. The oscillating unit 10 may include the wing unit 100 configured to have a disk structure so as to generate dynamic lift, a cylindrical sleeve 110 configured to support the wing unit 100, and a connection member 120 configured to connect the wing unit 100 and the sleeve 110.

More specifically, the wing unit 100 has a circular disk form when viewed from the top, has the hollow portion “h” formed at its center, and is inserted into the column 200. As shown in FIG. 5, the central part side of the wing unit 100 is slightly concaved, and thus is capable of forming a generally plate form. Furthermore, the wing unit 100 may have a symmetrical shape front and rear (i.e., the direction parallel to the X axis) and left and right (i.e., the direction parallel to the Y axis) on the basis of the central part.

In an embodiment of the present invention, the perpendicular section of the wing unit 100 may have an airfoil shape of a streamline form, and thus the wing unit 100 moves up and down by dynamic lift. Accordingly, the wind power generator according to an embodiment of the present invention generate electric energy using kinetic energy generated when the wing unit 100 moves up and down by dynamic lift. For reference, the perpendicular section may mean a section parallel to the Z direction.

In accordance with an embodiment of the present invention, at least one dimple 103 may be formed in a surface of the wing unit 100. The dimple of a specific size may be formed in a curved section that connects the leading edge and trailing edge of the wing unit 100, thereby being capable of controlling flow separation attributable to a rear current. In general, the dimples may be formed at specific intervals in a radial form in the cylindrical direction of the wing unit 100, but the number and positions of the dimples are not limited.

In an embodiment of the present invention, the wing unit 100 may have a different maximum thickness, camber, leading edge radius and length of chord line depending on embodiments. The wing unit 100 may be formed to have a structure capable of generating dynamic lift of high efficiency through an optimal design. In this case, an aerodynamic factor, such as an angle of attack, may need to be sufficiently taken into consideration.

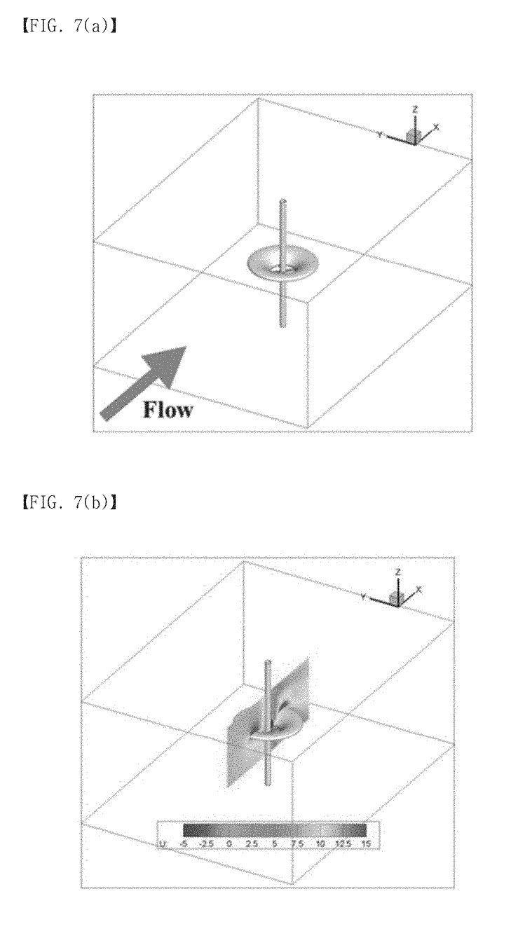

More specifically, the principle that dynamic lift is generated according to an embodiment of the present invention is described in more detail below with reference to FIGS. 7 to 9.

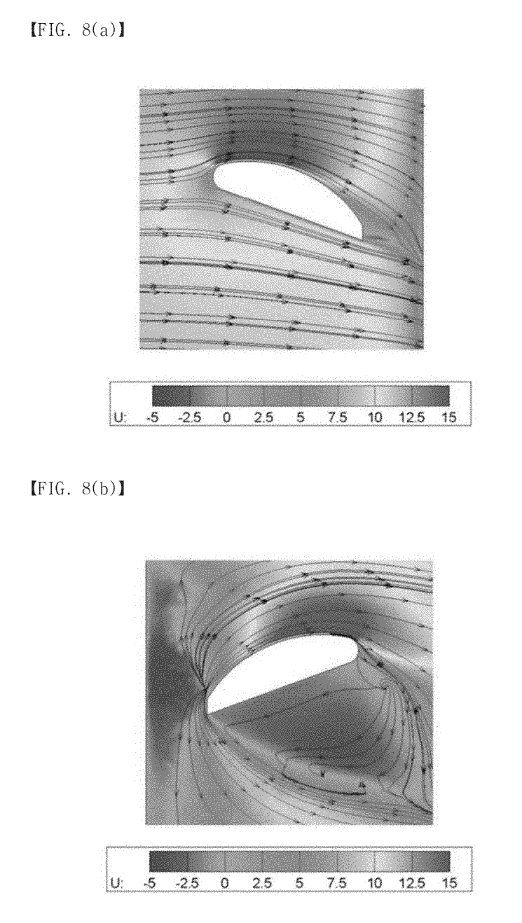

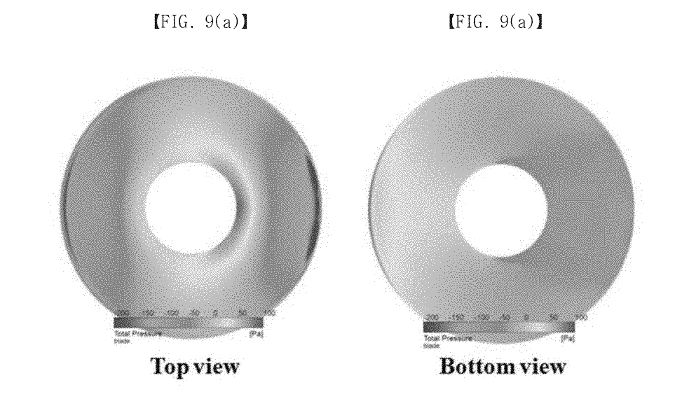

FIG. 7(a) shows a conceptual diagram of the wind power generator in which the wing unit and the column have been formed according to an embodiment of the present invention. FIG. 7(b) is a simulation diagram showing the current around the wing unit when the wind is applied to the wind power generator. FIG. 8(a) is an enlarged cross-sectional view of the FIG. 7 and is a simulation diagram showing the wing unit and the current around the wing unit that first comes into contact with the wind. FIG. 8(b) shows a flow around the section of the wing unit at a portion spaced 180 degrees apart from the wing unit of FIG. 8(a). FIGS. 9(a) and 9(b) are respectively a top view and bottom view of FIG. 8 and is a simulation diagram showing a pressure distribution on a surface of the wing unit.

When the wind is applied to the wind power generator according to an embodiment of the present invention, the air current around the wing unit 100 becomes irregular. More specifically, a flow of the air is slow on the lower side of the wing unit 100 of an airfoil shape because the lower side of the wing unit 100 is almost flat. In contrast, a flow of the air is fast on the upper side of the wing unit 100 because the upper side of the wing unit 100 is curved. Pressure on the lower side of the wing unit 100 is increased and pressure on the upper side of the wing unit 100 is decreased in accordance with Bernoulli's theorem, thereby generating dynamic lift, that is, a rising force.

Such a principle may be checked through the simulation results of FIGS. 8 and 9. Assuming that a flow blows in one direction, the wing unit experiences dynamic lift because there is a difference in the current of a specific size around the wing unit that first comes into contact with the wind, as shown in FIG. 8(a). FIG. 8(b) shows a flow around the section of the wing unit at a portion spaced 180 degrees apart from the wing unit of FIG. 8(a). In this case, the current becomes significantly irregular compared to the wing unit of FIG. 8(a) due to the influence of a rear current.

As shown in FIGS. 9(a) and 9(b), a difference in the current around the wing unit generates a pressure difference between the upper and lower parts of the wing unit, so dynamic lift is generated in the wing unit. As shown in FIG. 8(b), a greater current difference around the wing unit (more specifically, based on a stagnation point) that is greatly subjected to the influence of the rear current causes to further increase a pressure difference between the upper and lower parts of the wing unit. As a result, greater dynamic lift is generated in the wing unit.

In an embodiment of the present invention, a plurality of the oscillating units 10 may be formed. If the plurality of oscillating units 10 is formed, a plurality of the wing units 100, the sleeves 110 and the connection members 120, that is, the elements of the plurality of oscillating units 10, may also be formed.

Referring back to FIG. 4, the wing unit 100, that is, one of the elements of the oscillating unit 10, has been illustrated as having a first wing unit 100a and a second wing unit 100b, but is not essentially limited thereto. For example, in some embodiments, a third wing unit, a fourth wing unit, . . . , an (n)-th wing unit (n is a natural number) may be provided in the length direction of the column 200. In general, a larger number of the wing units 100 may be provided because the amount of power generation if the plurality of wing units 100 is provided is greater than that if a single wing unit 100 is provided. However, a proper number of the wing units 100 may be installed by taking into consideration various factors, such as the required amount of electric power, building environment, natural environment and equipment cost at an electricity consumption place.

If the plurality of oscillating units 10 is provided, the oscillating units 10 may independently operate to generate electric energy. For example, if the front wind blows to one oscillating unit 10 and the side wind blows to the other oscillating unit 10, each of the oscillating units 10 may independently operate with respect to the wind of each direction.

Referring back to FIG. 4, the wind power generator according to an embodiment of the present invention may include the cylindrical sleeve 110 for supporting the wing unit 100 and an elastic member 300 for elastically supporting the sleeve 110. The sleeve 110 supports the trailing edge of the wing unit 100. In this case, the sleeve 110 is elastically supported by the elastic member 300, and thus may move up and down along the column 200. The dimensions (e.g., height and length) of the sleeve 110 are not limited to specific numerical values, but may have values capable of having only to stably support the wing unit 100.

The wind power generation system according to an embodiment of the present invention may be designed to freely vibrate in the Z-axis direction because it includes the oscillating unit 10. In an embodiment, the wind power generation system further includes the elastic member 300 and thus can well vibrate even by small dynamic lift (or force).

Furthermore, in a conventional wind power generation system, if the wind is irregularly formed, power generation efficiency is not constant. In contrast, in the wind power generation system according to an embodiment of the present invention, although the wind blows irregularly and thus dynamic lift applied to the oscillating unit 10 is irregularly generated, the oscillating unit 10 can vibrate more freely up and down. In this case, since the elastic member 300 is further included, higher power generation efficiency can be achieved because vibration attributable to an elastic restoring force is accelerated by the elastic member 300.

The elastic member 300 functions to support the oscillating unit 10, and is formed in the length direction of the column 200. The elastic members 300 may be disposed to support the top and bottom of the oscillating unit 10, respectively. The elastic member 300 is formed to have a proper spring constant “k” so as to firmly support the up/down vibration of the oscillating unit 10. In this case, a compression/coil spring or a spiral spring may be used as the elastic member 300, but the present invention is not essentially limited thereto. If the oscillating unit 10 includes the sleeve 110, the elastic member 300 may be formed to support the sleeve 110. If the oscillating unit 10 does not include the sleeve 110, the elastic member 300 may be formed to support the trailing edge portion of the wing unit 100.

When the wind blows, upward dynamic lift is generated and thus the wing unit 100 moves upward, the elastic member 300 supporting the top of the oscillating unit 10 is compressed and the elastic member 300 supporting the bottom of the oscillating unit 10 is extended. In contrast, when dynamic lift is reduced, the wing unit 100 moves downward by the restoring force of the elastic member 300.

In some embodiments, when a strong downward wind blows, the elastic member 300 supporting the top of the oscillating unit 10 may be extended and the elastic member 300 supporting the bottom of the oscillating unit 10 may be compressed. In this case, various loads, such as the self weight of the wing unit 100, in the elastic member 300 supporting the bottom of the oscillating unit 10 are greater than those in the elastic member 300 supporting the top of the oscillating unit 10. Accordingly, the elastic member 300 supporting the bottom of the oscillating unit 10 may have a higher spring constant than the elastic member 300 supporting the top of the oscillating unit 10.

Referring to FIG. 4, the sleeve 110 and the elastic member 300 according to an embodiment of the present invention have been illustrated as being disposed outside the tower, but are not limited thereto. In some embodiments, in order to secure airtightness, the sleeve 110 and the elastic member 300 may be disposed within the tower.

Furthermore, if a plurality of the oscillating units 10 is formed, a single sleeve 110 or a plurality of the sleeves 110 may be used. For example, a single sleeve 110 connected to all of a plurality of the wing units 100 may be used, or a plurality of the sleeves 110 that are connected to a plurality of the wing units 100, respectively, and separated from each other may be used.

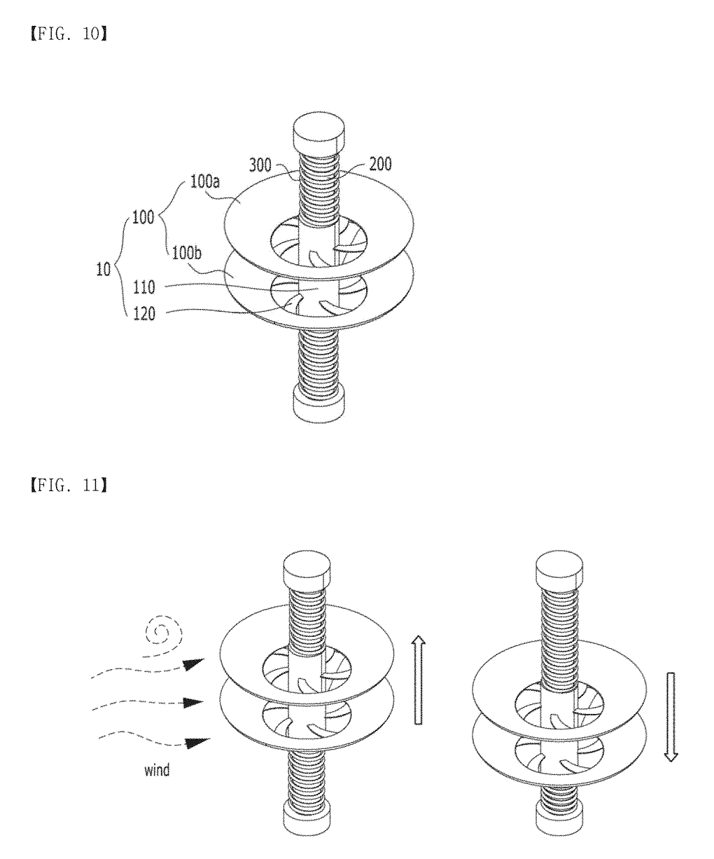

A wind power generator according to another embodiment of the present invention is described below with reference to FIGS. 10 and 11.

FIG. 10 is a perspective view of the wind power generation system according to another embodiment of the present invention. FIG. 11 is a diagram showing the principle that the wind power generator of FIG. 10 operates.

In the wind power generator according to another embodiment of the present invention, a gap for a flow of a fluid may be formed between the wing unit 100 and the sleeve 110. At least one connection member 120 may be formed to connect the wing unit 100 and the sleeve 110.

The gap for a flow of a fluid is the space formed between the wing unit 100 and the sleeve 110 and may be provided to increase efficiency of the generation of dynamic lift when the wing unit 100 moves up and down. The connection member 120 corresponds to an element that connects the trailing edge of the wing unit 100 and the sleeve 110. The at least one connection member 120 may be provided. If the plurality of connection members 120 is provided, it may be spaced apart from each other at the same interval in a radial form around the central axis of the column 200. The plurality of connection members 120 may be disposed in a spiral or streamline form in order to not hinder a flow of air. Furthermore, the connection member 120 may have a sectional form of an airfoil form by taking into consideration dynamic lift.

FIG. 11 shows the principle of the oscillating motions(ex) up/down motions) of the wind power generator according to the present embodiment. According to the same principle as that of the aforementioned embodiment, when the wind blows, upward dynamic lift is generated and thus the wing unit 100 moves up, an elastic member 300a supporting the top of the sleeve 110 is compressed and an elastic member 300b supporting the bottom of the sleeve 110 is extended. In contrast, when dynamic lift is reduced, the wing unit 100 moves down by the restoring force of the elastic member 300.

In some embodiments, when a strong downward wind blows, the elastic member 300a supporting the top of the sleeve 110 may be extended and the elastic member 300b supporting the bottom of the sleeve 110 may be compressed. In the present embodiment, unlike in the aforementioned embodiment, the gap is formed between the wing unit 100 and the sleeve 110 and thus generated dynamic lift is greatly influenced. Accordingly, the compression/extension distance of the elastic member 300 can be further increased compared to the aforementioned embodiment.

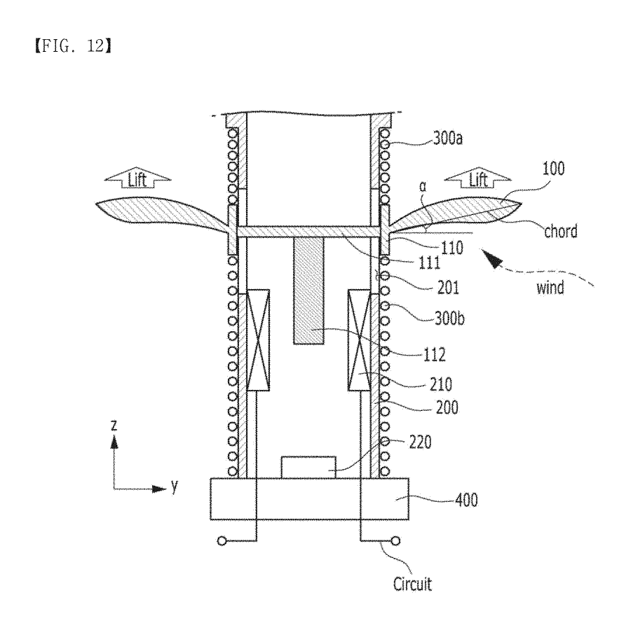

A mechanism for converting mechanical (or dynamic) energy into electric energy is described in detail below with reference to FIGS. 12 to 17.

An electromagnetic induction method or a piezoelectric method may be used as the energy conversion mechanism according to an embodiment of the present invention. The electromagnetic induction method or the piezoelectric method may be considered to be a linear-type power generation mechanism.

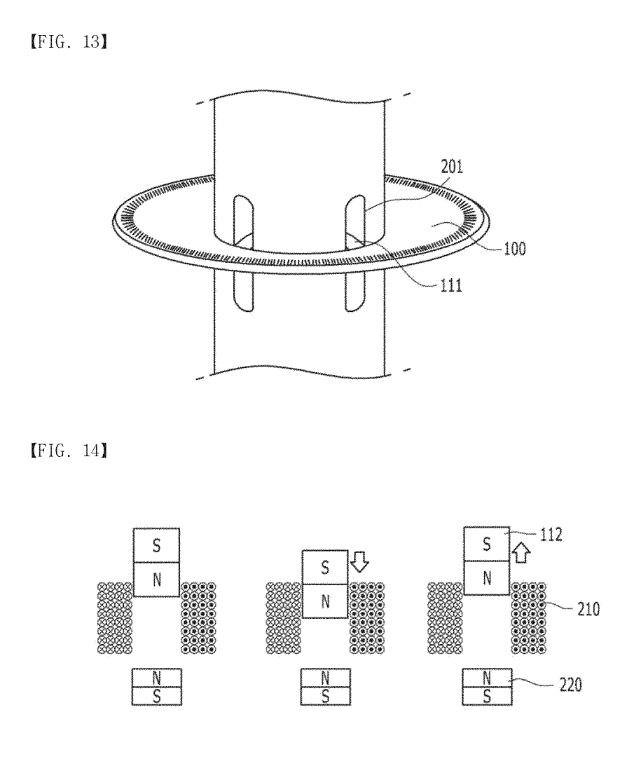

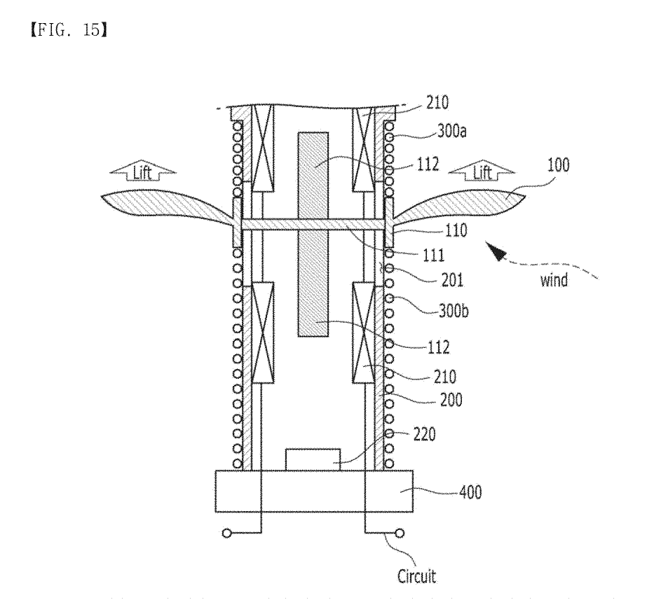

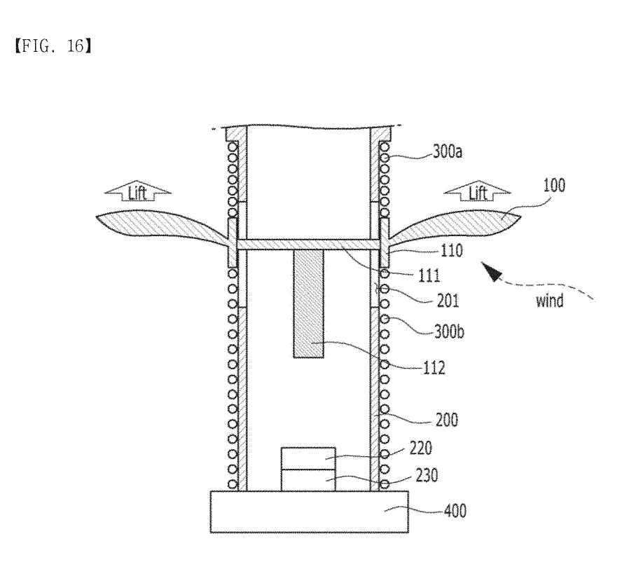

FIG. 12 is a diagram showing the internal structure of the wind power generation system using the electromagnetic induction method. FIG. 13 is a diagram showing a slit structure of the wind power generation system according to an embodiment of the present invention. FIG. 14 is a diagram showing the operating principle of FIG. 12. FIG. 15 is a diagram showing a wind power generation system using the electromagnetic induction method according to another embodiment. FIG. 16 is a diagram showing the internal structure of the wind power generation system using the piezoelectric method. FIG. 17 is a diagram showing the operating principle of FIG. 16.

First, referring to FIG. 12, a main magnetic body 112 for generating electric energy in synchronization with the up or down motion of the oscillating unit 10 may be provided within a column 200. A coil 210 may be disposed around the main magnetic body 112.

The main magnetic body 112 may be supported by a guide bar 111 and extended in the perpendicular direction. The coil 210 may be fixed to the internal wall of the column 200 and disposed to surround the main magnetic body 112. The direction in which the main magnetic body 112 extends has been illustrated as being downward in FIG. 12, but is not essentially limited thereto.

Referring to FIGS. 12 and 13, the guide bar 111 is an element provided to move up or down within the column 200. The guide bar 111 may have one end and the other end inserted into a slit 201 provided on one side of the column 200 and may be directly connected to the wing unit 100 or may be indirectly connected to the wing unit 100 through the medium of the sleeve 110. The present invention may include various embodiments in which the slit 201 and the guide bar 111 form a rack and pinion structure or the inner circumference of the slit 201 has a rail structure and the guide bar 111 has a shape corresponding to the rail structure so that the oscillating unit 10 can smoothly vibrate.

The guide bar 111 moves up or down in response to the perpendicular up or down motion of the oscillating unit 10. Accordingly, the main magnetic body 112 moves up or down. At this time, electromagnetic induction is generated due to a change in the relative position between the main magnetic body 112 and the coil 210 because the coil 210 is wound and disposed around the main magnetic body 112. Electric power induced along an electrical circuit connected to the coil 210 may be collected.

The principle of the electromagnetic induction method is illustrated in FIG. 14. When the main magnetic body 112 moves forward or backward on the basis of the wound coil, an induction current is generated in the coil 210, and electric energy can be accumulated using the generated induction current.

As shown in FIG. 12, an auxiliary magnetic body 220 may be provided at the lower end of the tower. The auxiliary magnetic body 220 has polarity different from that of the main magnetic body 112. For example, if the N polarity of the main magnetic body 112 is opposite the polarity of the auxiliary magnetic body 220, the upper part of the auxiliary magnetic body 220 also has the N polarity so that it is opposite the main magnetic body 112. Alternatively, if the S polarity of the main magnetic body 112 is opposite the polarity of the auxiliary magnetic body 220, the upper part of the auxiliary magnetic body 220 also has the S polarity so that it is opposite the main magnetic body 112. The main magnetic body 112 can be prevented from colliding against the auxiliary magnetic body 220 when it moves down because a repulsive force acts on between the two magnetic bodies. In this case, the main magnetic body 112 and the auxiliary magnetic body 220 may be formed to have an axis concentric with the axial direction of the column from a viewpoint of stability.

In another embodiment, the wind power generator of FIG. 15 may have a construction in which the oscillating unit 10 includes the two main magnetic bodies 112, one of the main magnetic bodies 112 is connected to the bottom of the guide bar 111 and the other of the main magnetic bodies 112 is connected to the top of the guide bar 111. In this case, power generation efficiency can be further improved compared to the wind power generator of FIG. 12.

The principle that the wind power generator according to another embodiment of the present invention operates is described below.

Referring to FIGS. 16 and 17, the main magnetic body 112 and the auxiliary magnetic body 220 are provided, and a piezoelectric unit 230 may be disposed under the auxiliary magnetic body 220. Specifically, the piezoelectric unit 230 may include a piezoelectric element 231 and electrodes 232 and 233. More specifically, the piezoelectric element 231 may correspond to a piezoelectric material, such as a bulk piezoelectric body or a piezoelectric spring. More specifically, a piezoelectric material whose top and bottom surfaces have an electrical potential difference in response to deformation in a thickness direction may be used as the piezoelectric element 231.

When the main magnetic body 112 moves down, a force that presses downward is applied to the auxiliary magnetic body 220 by a repulsive force. The downward pressing force is transferred to the piezoelectric unit 230. At this time, the piezoelectric element 231 is deformed in its thickness direction. An electric current flows between the electrodes 232 and 233 due to an electrical potential attributable to the deformation in the thickness direction. At this time, electric energy can be accumulated by collecting the generated electric current.

When the main magnetic body 112 moves up, the downward pressing force applied to the auxiliary magnetic body 220 is reduced. Such a change in the force causes deformation in the thickness direction of the piezoelectric element 231. An electric current flows between the electrodes 232 and 233 due to an electrical potential attributable to the deformation in the thickness direction. At this time, the flow of the electric current is opposite that of the electric current when the main magnetic body 112 moves down.

The wind power generator according to an embodiment of the present invention can convert mechanical energy into electric energy through such a power generation mechanism.

In some embodiments, a rotary type power generation mechanism other than the linear-type power generation mechanism may be used as in existing blade type wind power generators. For example, if a straight-line motion is converted into a rotary motion in one direction using a slider-crank mechanism, power generation can be performed like the existing form. Accordingly, the present invention can be technically compatible with a conventional wind power generation system.

Some embodiments of the wind power generator are additionally described below.

The wing unit 100 according to an embodiment of the present invention may be a variable wing unit that varies so that an upper half surface of the perpendicular section of the wing unit is wider than the width of the lower half surface thereof while the wing unit moves up and the upper half surface of the perpendicular section of the wing unit is narrower than the width of the lower half surface thereof while the wing unit moves down. In other words, the airfoil shape of the wing unit 100 is not fixed, but may vary. The variable wing unit functions to supplement a dynamic lift mechanism when the wing unit moves down, which may be slightly weaker than a dynamic lift mechanism when the wing unit moves up. Such an embodiment may be implemented by configuring the wing unit 100 in the form of a plurality of pieces and configuring the plurality of pieces so that they are deformed in the best form in response to a flow around the wing unit 100.

In another embodiment, the wing unit 100 may be formed so that an included angle “a” formed by the chord line of the wing unit 100 and a virtual plane orthogonal to the central axis of the column 200 is varied. In this case, the included angle “a” may mean an included angle “a” shown in FIG. 12. An angle of attack at which the best dynamic lift is generated may be adjusted depending on quality of the wind and the direction of the wind applied to the wind power generator. Such an embodiment may also be implemented by configuring the wing unit 100 in the form of a plurality of pieces or changing an angle of the connection member 120 connected to the trailing edge of the wing unit 100.

To this end, the wind power generator according to an embodiment of the present invention may further include a control unit (not shown) and a driving actuator (not shown) which enable a fine operation of the wing unit 100 to be artificially manipulated. Such an embodiment may be configured so that it is performed only when the amount of power generation is greater as a result of a comparison between the amount of power generation and electric energy consumed for the control operation.

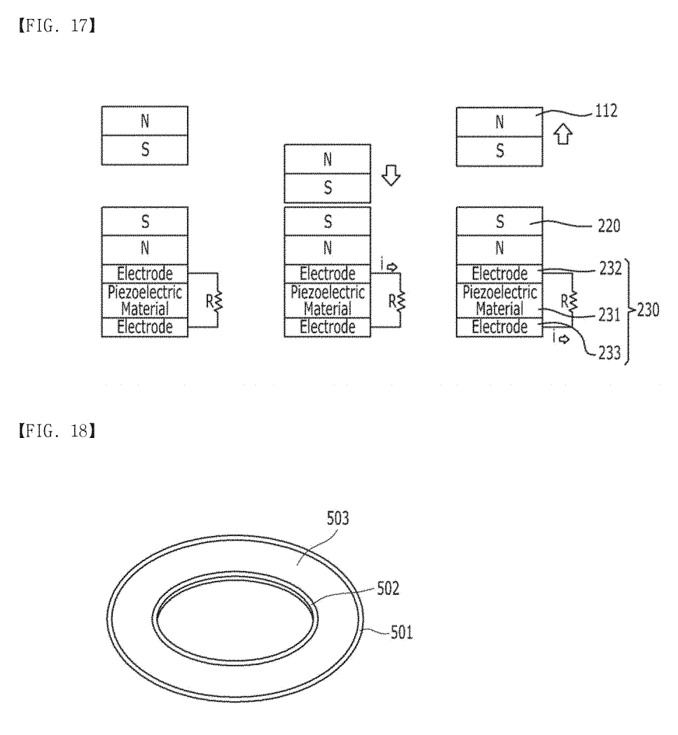

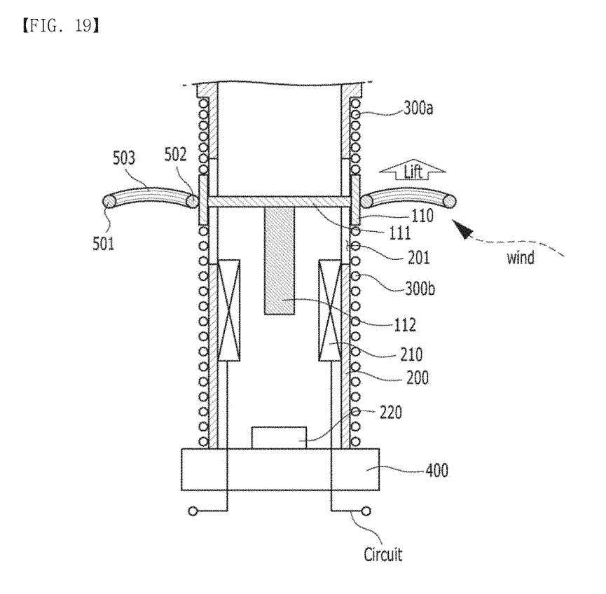

Another example of the variable wing unit is described below with reference to FIGS. 18 to 20.

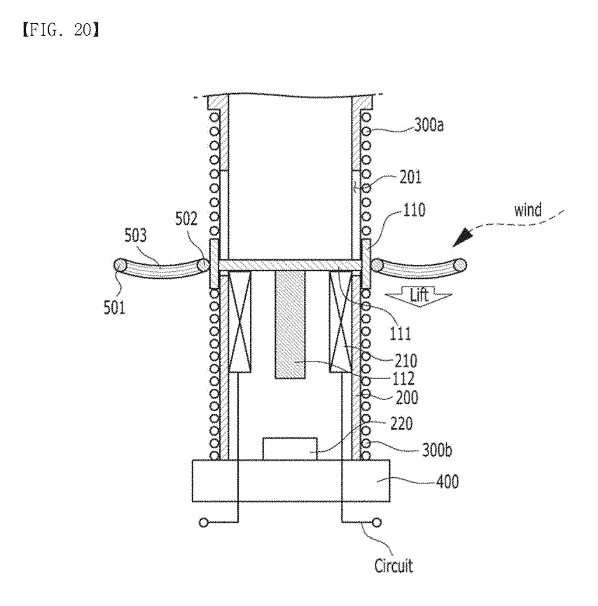

FIG. 18 is a diagram showing a wind power generation system using a wing unit to which a canopy has been applied. FIG. 19 is a diagram showing the principle that the wing unit of FIG. 18 moves up. FIG. 20 is a diagram showing the principle that the wing unit of FIG. 18 moves down.

As shown in FIG. 18, the wing unit 100 may include a first ring member 501 forming the outside diameter of a disk, a second ring member 502 forming the inside diameter of the disk, and a canopy 503 connecting the first ring member 501 and the second ring member 502. The second ring member 502 is firmly connected to the guide bar 111 or the sleeve 110 or the connection member 120.

The canopy 503 may be made of a flexible material, such as nylon. When an ascending air current is formed around the wind power generator, the canopy 503 may swell, may move up, and may be subjected to dynamic lift. When the dynamic lift is weakened, the canopy 503 may restore to its original state. When a descending air current is formed around the wind power generator, the canopy 503 may swell, may move down, and may be subjected to dynamic lift.

In accordance with an embodiment of the present invention, problems, such as a rotor noise in a conventional wind power generation system and a wide shadow around the wind power generation system, can be reduced. Furthermore, a bird collision problem can be effectively solved.

In accordance with an embodiment of the present invention, power can be generated in response to the wind in all directions because the oscillating unit of a disk form which is easy to be subjected to dynamic lift is used. Accordingly, there is an advantage in that space efficiency can be improved and an equipment cost can be reduced because elements for yawing as in a conventional blade type turbine system are not required.

In accordance with an embodiment of the present invention, wind power generation can continue to be performed even in a frequent change in the direction of the wind because the wind unit has a structure capable of vibrating up or down. Furthermore, a dense wind power plant can be easily designed because a rear current is smaller than that of the blade type power generator.

In accordance with an embodiment of the present invention, a mechanical mechanism structure is simple compared to an existing bladeless type energy conversion device because the direction of vibration is constant.

In a wind power generation system according to a conventional technology, the size of the rotor must be increased in order to enhance the amount of power generation. Accordingly, residential acceptivity is very low because the size of the tower is huge. In contrast, in accordance with an embodiment of the present invention, the wind power generation system has a less limit to build because it occupies a less space for a disk behavior and thus it can be designed at a lower height compared to the high tower type structure of an existing wind power generation system. Accordingly, there is an advantage in that residential acceptivity can be improved compared to a wind power generation system according to a conventional technology.

In the detailed description of the present invention, only some special embodiments of the present invention have been described. It is however to be understood that the present invention is not limited to the special embodiments described in the detailed description, but should be construed as including all of changes, equivalents and substitutes without departing from the spirit and range of right of the present invention defined by the appended claims.

Those skilled in the art to which the present invention pertains may modify and change the present invention in various ways without departing from the spirit and range of right of the present invention.

The range of right of the present invention is defined by the appended claims rather than the detailed description, and the present invention should be construed as covering all of modifications or variations derived from the meaning and scope of the appended claims and equivalents thereof.

What is claimed is:

1. A wind power generation system, comprising:
a column; and
an oscillating unit,
wherein the oscillating unit comprises a wing unit of a disk form having a hollow portion formed in the wing unit in such a way to surround the column, whereby the wing unit converts kinetic energy into electric energy when the wing unit moves up or down by dynamic lift.

2. The wind power generation system of claim 1, wherein:
a perpendicular section of the wing unit has an airfoil shape having a virtual chord line which connects a leading edge forming an outermost circumference and a trailing edge forming an innermost circumference around a central axis of the column, and
the perpendicular section of the wing unit has an asymmetrical section in which an upper half surface has a wider width than a lower half surface.

3. The wind power generation system of claim 1, wherein the wind power generation system comprises a plurality of the oscillating units.

4. The wind power generation system of claim 1, wherein the oscillating unit further comprises a cylindrical sleeve supporting the wing unit.

5. The wind power generation system of claim 4, wherein:
a gap for a flow of a fluid is formed between the wing unit and the sleeve, and
at least one connection member is formed to connect the wing unit and the sleeve.

6. The wind power generation system of claim 1, further comprising an elastic member elastically supporting the oscillating unit.

7. The wind power generation system of claim 6, wherein:
the elastic member comprises an elastic member supporting a bottom of the oscillating unit and an elastic member supporting a top of the oscillating unit, and
the elastic member supporting the bottom of the oscillating unit has a higher spring constant than the elastic member supporting the top of the oscillating unit.

8. The wind power generation system of claim 1, wherein at least one dimple is formed in a surface of the wing unit.

9. The wind power generation system of claim 1, wherein the conversion of the kinetic energy into the electric energy is performed using an electromagnetic induction method, a piezoelectric method or a slider-crank method.

10. The wind power generation system of claim 1, wherein:
a main magnetic body for generating electric energy in synchronization with the up or down motion of the oscillating unit is provided within the column, and
a coil is disposed around the main magnetic body.

11. The wind power generation system of claim 10, further comprising a guide unit configured to support the main magnetic body and to guide a perpendicular motion of the oscillating unit,
wherein the main magnetic body is disposed at each of a top and bottom of the guide unit.

12. The wind power generation system of claim 1, wherein:
a main magnetic body disposed to generate electric energy in synchronization with the up or down motion of the oscillating unit and an auxiliary magnetic body disposed to face the main magnetic body are provided within the column, and
the auxiliary magnetic body has polarity different from polarity of the main magnetic body so that a repulsive force is formed between the auxiliary magnetic body and the main magnetic body.

13. The wind power generation system of claim 12, wherein a piezoelectric unit is disposed under the auxiliary magnetic body.

14. The wind power generation system of claim 1, wherein the wing unit comprises a variable wing unit configured to vary so that an upper half surface of a perpendicular section of the wing unit has a wider width than a lower half surface of the perpendicular section during the up motion and the upper half surface of the perpendicular section of the wing unit has a narrower width than the lower half surface during the down motion.

15. The wind power generation system of claim 1, wherein the wing unit comprises a variable wing unit configured to change an included angle formed by a chord line and a virtual plane orthogonal to a central axis of a column.

16. The wind power generation system of claim 1, further comprising a control unit and a driving actuator which enable a fine operation of the wing unit to be artificially manipulated.

17. The wind power generation system of claim 1, wherein the wing unit comprises:
a first ring member configured to form a circumference of a leading edge of the wing unit,
a second ring member configured to form a circumference of a trailing edge of the wing unit, and
a canopy connected between the first ring member and the second ring member.

18. The wind power generation system of claim 17, wherein the canopy is made of a flexible material and has a varying section shape.
